(19) United States
(12) Patent Application Publication
(10) Pub. No.: US 2014/0267051 A1
(43) Pub. Date: Sep. 18, 2014

(54) HYBRID AVIATION USER INTERFACE

(71) Applicant: Garmin International, Inc., Olathe, KS (US)

(72) Inventor: Joseph L. Komer, Lenexa, KS (US)

(73) Assignee: Garmin International, Inc., Olathe, KS (US)

(21) Appl. No.: 13/957,165

(22) Filed: Aug. 1, 2013

Related U.S. Application Data
(60) Provisional application No. 61/783,876, filed on Mar. 14, 2013.

(51) Int. Cl. G06F 3/02; G06F 3/041

(52) U.S. Cl. CPC G06F 3/02; G06F 3/041
USPC 345/168

(57) ABSTRACT

A controller for an integrated avionics system and a method of operation of the controller is described herein. The controller includes a keyboard and a touch screen. Further, the controller provides hybrid functionality, such that a user can enter inputs (e.g., navigational data) into the controller via a keyboard-initiated input sequence, or via a touch screen-initiated input sequence. This hybrid functionality provides a user interface having the speed advantages associated with keyboard (scratchpad line select) input entry, while also providing the intuitive touch screen interface.

### CROSS-REFERENCE TO RELATED APPLICATIONS

This application claims priority to U.S. Provisional Application No. 61/783,876 filed on Mar. 14, 2013, entitled: “Hybrid Aviation User Interface”, which is hereby incorporated by reference in its entirety.

### BACKGROUND

Integrated avionics systems replace mechanical and electro-mechanical instrument gauges historically used in aircraft with one or more electronic displays for displaying primary flight information such as attitude, altitude, heading, vertical speed, and so forth, to the pilot. Integrated avionics systems may include one or more primary flight displays (PFD) and one or more multifunction displays (MFD). A representative PFD displays primary flight and selected navigation information that is typically received from one or more sensor systems such as an attitude heading reference system (AHRS), an inertial navigation system (INS), one or more air data computers (ADC) and/or navigation sensors. A representative MFD displays information for navigation and for broad situational awareness such as navigation routes, flight plans, information about aids to navigation (including airports), moving maps, weather information, terrain and obstacle information, traffic information, engine and other aircraft systems information, flight management system (FMS) functionality, and so forth.

### SUMMARY

A controller for an integrated avionics system and a method of operation of the controller is described herein. The controller includes a keyboard (e.g., a physical keyboard) and a touch screen. Further, the controller provides hybrid functionality, such that a user can enter inputs (e.g., navigational data) into the controller via a keyboard-initiated input sequence, or via a touch screen-initiated input sequence. This hybrid functionality provides a user interface having the speed advantages associated with keyboard input entry and commonality with legacy systems, while also providing the intuitive touch screen interface.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are exemplary and explanatory only and are not necessarily restrictive of the subject matter claimed.

### BRIEF DESCRIPTION OF THE DRAWING FIGURES

The detailed description is described with reference to the accompanying figures. The use of the same reference numbers in different instances in the description and the figures may indicate similar or identical items.

FIG. 1 is a block diagram illustrating an integrated avionics system configured in accordance with an exemplary embodiment of the present disclosure.

FIG. 2 is a block diagram illustrating an integrated avionics unit (TAU) of the example integrated avionics system shown in FIG. 1, in accordance with an exemplary embodiment of the present disclosure.

FIG. 3 is a block diagram illustrating a controller of the integrated avionics system shown in FIG. 1, in accordance with an example implementation of the present disclosure.

FIG. 4 is an illustration depicting an example embodiment of the controller shown in FIG. 3, the controller including a display unit and a keyboard (e.g., a physical keyboard), the keyboard being connected to the display unit, the keyboard including a scratchpad and quick access keys in accordance with an example implementation of the present disclosure.

FIG. 5 is an illustration depicting an example embodiment of the controller shown in FIG. 3, the controller including a display unit and a keyboard, the keyboard being connected to the display unit, the display unit including a scratchpad in accordance with an example implementation of the present disclosure.

FIGS. 6A and 6B are illustrations depicting an example embodiment of the controller in which a new standby frequency value is being input to the controller via a keyboard-initiated input sequence in accordance with an example implementation of the present disclosure.

FIGS. 7A and 7B are illustrations depicting an example embodiment of the controller in which a waypoint is being added to a flight plan page displayed by the controller via a keyboard-initiated input sequence in accordance with an example implementation of the present disclosure.

FIGS. 8A and 8B are illustrations depicting an example embodiment of the controller in which a runway extension waypoint is being added to a flight plan page displayed by the controller via a keyboard-initiated input sequence in accordance with an example implementation of the present disclosure.

FIGS. 9A and 9B are illustrations depicting an example embodiment of the controller in which an along track offset waypoint is being added to a flight plan page displayed by the controller via a keyboard-initiated input sequence in accordance with an example implementation of the present disclosure.

FIG. 10 is a flowchart illustrating an exemplary process performed by the controller in accordance with an exemplary embodiment of the present disclosure.

FIG. 11 is an illustration depicting an example embodiment of the controller in which a touch sequence is utilized to enter a communication frequency.

The drawing figures do not limit the system to the specific implementations disclosed and described herein. The drawings are not necessarily to scale, emphasis instead being placed upon clearly illustrating elements of the system.

### DETAILED DESCRIPTION

### Overview

Some integrated avionics systems implemented on-board an aircraft provide one or more controllers, such as one or more avionics control and display units (CDU), which may provide a user interface (e.g., a touch interface) for allowing a pilot of the aircraft to control the functions of the primary flight displays (PFD) and/or the multifunction displays (MFD) of the avionics system and to enter navigational data into the avionics system.

Some of these currently implemented controllers provide a touch screen user interface which allows a user to touch what the user wants to do or change. For example, if the user wants to enter a new speed target value for the aircraft, the user can provide an input using a touch button labeled “speed target” displayed by the touch screen. The touch screen then prompts the user with a pop-up on-screen keyboard screen or a pop-up on-screen selection menu listing data values to use for the specified data field. Once prompted, the user can type in the new speed target value using the virtual keyboard prompt on the touch screen. The user can then touch an “enter” button displayed by the touch screen, and the system then places the new speed target value into the speed target touch button.

A second category of currently implemented controllers provide a user interface which combines a keyboard (e.g., a physical keyboard) and a display. With the second category of currently implemented controllers, the user provides an input (e.g., data, text, syntax, a new speed target value), which then appears in a virtual scratchpad on the display. The user then provides another input by pressing a line select key (LSK) on the display. The line select keys may have data fields displayed next to them. For example, if the user wants to enter a new speed target value, the user types the new speed target value using the physical keyboard and then presses the line select key next to the data field labeled “speed target”. The line select key input tells the system what the user is trying to do with the data which appears in the keyboard scratchpad or where to try to use the data which appears in the keyboard scratchpad. The controller then processes the inputs, including parsing the data which appears in the keyboard scratchpad to determine if it can do something with it.

The first category of currently implemented controllers has a number of advantages over the second category. For example, they are more intuitive and require less training to use. Further, they do not require memorization of syntax. Further, they only show keys which are needed for a current operation. Further, unlike the second category of currently implemented controllers, which are constrained by the keys on their keyboards, the first category of currently implemented controllers provides greater flexibility and makes it easier to add new features. Still further, the first category of currently implemented controllers avoids errors caused by using improper syntax. However, a number of disadvantages are associated with the first category of currently implemented controllers. For example, they may require more keystrokes from a user than the second category. Further, with the first category of currently implemented controllers, a user is unable to start typing something first, and then decide where to put it.

Given the above differences, it can be cumbersome for pilots trained on one of the above-referenced two categories of currently implemented controllers to transition to using a controller of the other category. The system and method described herein address this difficulty by providing a controller which provides hybrid functionality.

In one or more implementations described herein, the controller provides a user interface which combines a keyboard (e.g., physical keyboard) and a touch screen. This combination allows a user to initiate an input sequence using either the keyboard or the touch screen. For example, if the user wants to enter a new speed target value for the aircraft, the user can initiate an input sequence for doing so by first providing an input via the keyboard. The keyboard-provided input then appears (e.g., as text, syntax, and/or data) in a scratchpad (of either the keyboard or the touch screen). The input provided via the keyboard may include the new speed target value. The user then provides an input to the touch screen by touching a touch button associated with (e.g., labeled) speed target. Providing the input via the touch button rather than using a line select key, allows a user to bypass unnecessary (e.g., non-related) pop-ups. The controller then processes the inputs, including: checking the scratchpad and determining that there is data in the scratchpad, parsing the data in the scratchpad to determine if it can use the data (e.g., to determine if the data is valid for that touch button), and, when it determines that it can use the data (e.g., that the data corresponds to a proper input for changing the speed target value), changing the speed target value to the input value (e.g., entering the data).

Alternatively, if the user wants to enter a new speed target value for the aircraft, the user can initiate an input sequence for doing so by first providing an input via a touch button displayed on the touch screen, the touch button associated with (e.g., labeled) speed target. The controller, when processing the input, determines that there is no data in the scratchpad, then causes the touch screen to display a prompt, such as a context-specific data entry field or window, for allowing the user to enter the new speed target value. The user may then utilize the keyboard for typing the new speed target value into the data entry field or window displayed on the touch screen. The controller then processes the keyboard input, and changes the speed target value to the speed target value input by the user (e.g., the controller enters the data).

The above-referenced hybrid functionality provided by the herein described system (e.g., controller) and method, which is further discussed below, allows users trained on either of the two above-referenced currently implemented categories of controller to efficiently use the herein described controller to provide inputs. It achieves this by providing the speed advantages associated with physical keyboard entry (e.g., scratchpad/line select entry), while also providing the intuitive touch screen interface.

Example Environment

FIG. 1 illustrates an environment in an example implementation that includes an integrated avionics system 100 in accordance with the techniques of the present disclosure. The integrated avionics system 100 may include one or more primary flight displays (PFDs) 102, and one or more multifunction displays (MFD) 104. For instance, in the implementation illustrated in FIG. 1, the integrated avionics system 100 may be configured for use in an aircraft that is flown by a flight crew having two pilots (e.g., a pilot and a co-pilot). In this implementation, the integrated avionics system 100 may include a first PFD 102(1), a second PFD 102(2), and an MFD 104 that are mounted in the aircraft's instrument panel. The MFD 104 is mounted generally in the center of the instrument panel so that it may be accessed by either pilot (e.g., by either the pilot or the copilot). The first PFD 102(1) is mounted in the instrument panel generally to the left of the MFD 104 for viewing and access by the pilot. Similarly, the second PFD 102(2) is mounted in the instrument panel generally to the right of the MFD 104 for viewing and access by the aircraft's copilot or other crew member or passenger.

The PFDs 102 may be configured to display primary flight information, such as aircraft attitude, altitude, heading, vertical speed, and so forth. In implementations, the PFDs 102 may display primary flight information via a graphical representation of basic flight instruments such as an attitude indicator, an airspeed indicator, an altimeter, a heading indicator, a course deviation indicator, and so forth. The PFDs 102 may also display other information providing situational awareness to the pilot such as terrain information and ground proximity warning information.

As shown in FIG. 1, primary flight information may be generated by one or more flight sensor data sources including, for example, one or more attitude, heading, angular rate, and/or acceleration information sources such as attitude and heading reference systems (AHRS) 106, one or more air data information sources such as air data computers (ADC) 108, and/or one or more angle of attack information sources. For instance, in one implementation, the AHRSs 106 may be configured to provide information such as attitude, rate of turn, and/or slip and skid, while the ADCs 108 may be configured to provide information including airspeed, altitude, vertical speed, and outside air temperature. Other configurations are possible.

One or more avionics units 110 (e.g., a single integrated avionics unit (IAU) is illustrated) may aggregate the primary flight information from the AHRSs 106 and ADCs 108 and provide the information to the PFDs 102 via an avionics data bus 112. The avionics unit 110 may also function as a combined communications and navigation radio. For example, as shown in FIG. 2, the avionics unit 110 may include a two-way Very High Frequency (VHF) communications transceiver 202, a VHF navigation receiver with glide slope 204, a global navigation satellite system (GNSS) receiver such as a global positioning system (GPS) receiver 206, or the like, an avionics data bus interface 208, a processor 210, a memory 212 including a traffic display module 214, and so forth.

The processor 210 provides processing functionality for the avionics unit 110 and may include any number of processors, micro-controllers, or other processing systems and resident or external memory for storing data and other information accessed or generated by the avionics unit 110. The processor 210 may execute one or more software programs which implement techniques described herein. The processor 210 is not limited by the materials from which it is formed or the processing mechanisms employed therein, and as such, may be implemented via semiconductor(s) and/or transistors (e.g., electronic integrated circuits (ICs)), and so forth.

The memory 212 is an example of computer-readable media that provides storage functionality to store various data associated with the operation of the avionics unit 110, such as the software programs and code segments mentioned above, or other data to instruct the processor 210 and other elements of the avionics unit 110 to perform the functionality described herein. Although a single memory 212 is shown, a wide variety of types and combinations of memory may be employed. The memory 212 may be integral with the processor 210, stand-alone memory, or a combination of both. The memory 212 may include, for example, removable and non-removable memory elements such as Random Access Memory (RAM), Read-Only Memory (ROM), Flash (e.g., Secure Digital (SD) Card, mini-SD card, micro-SD Card), magnetic, optical, Universal Serial Bus (USB) memory devices, and so forth.

The avionics data bus interface 208 furnishes functionality to enable the avionics unit 110 to communicate with one or more avionics data buses such as the avionics data bus 112. In various implementations, the avionics data bus interface 208 may include a variety of components, such as processors, memory, encoders, decoders, and so forth, and any associated software employed by these components (e.g., drivers, configuration software, etc.).

As shown in FIG. 1, the integrated avionics unit 110 may be paired with a primary flight display (PFD) 102, which may function as a controlling unit for the integrated avionics unit 110. In implementations, the avionics data bus 112 may comprise a high speed data bus (HSDB), such as data bus complying with Aeronautical Radio, Incorporated 429 (ARINC 429) data bus standard promulgated by the Airlines Electronic Engineering Committee (AEEC), a Military-Standard-1553 (MIL-STD-1553) compliant data bus, and so forth.

The MFD 104 displays information describing operation of the aircraft, such as navigation routes, moving maps, engine gauges, weather radar, terrain awareness and warning systems (TAWS) warnings, traffic collision avoidance system (TCAS) warnings, airport information, and so forth, that are received from a variety of aircraft systems via the avionics data bus 112.

In implementations, the integrated avionics system 100 employs redundant sources of primary flight information to assure the availability of the information to the pilot, and to allow for cross-checking of the sources of the information. For example, the integrated avionics system 100 illustrated in FIG. 1 employs two PFDs 102, that receive primary flight information from redundant AHRSs 106 and ADCs 108, via the avionics unit 110. The integrated avionics system 100 is configured so that the first PFD 102(1) receives a first set of primary flight information aggregated by the avionics unit 110 from a first AHRS 106(1) and ADC 108(1). Similarly, the second PFD 102(2) receives a second set of primary flight information aggregated by the avionics unit 110 from a second AHRS 106(2) and ADC 108(2). Additionally, although a single avionics unit 110 and a single avionics data bus 112 are illustrated in FIG. 1, it is contemplated that redundant IAU's and/or redundant data buses may be employed for communication between the various components of the integrated avionics system 100.

In implementations, primary flight information provided by either the first AHRS 106(1) and ADC 108(1) or the second AHRS 106(2) and ADC 108(2) may be displayed on either PFD 102(1) or 102(2), or on the MFD 104 upon determining that the primary flight information received from either AHRS 106 and ADC 108 is in error or unavailable. One or both of the PFDs 102 may also be configured to display information shown on the MFD 104 (e.g., engine gauges and navigational information), such as in the event of a failure of the MFD 104.

The integrated avionics system 100 may employ cross-checking of the primary flight information (e.g., attitude information, altitude information, etc.) to determine if the primary flight information to be furnished to either of the PFDs 102 is incorrect. In implementations, cross-checking may be accomplished through software-based automatic continual comparison of the primary flight information provided by the AHRS 106 and ADC 108. In this manner, a “miss-compare” condition can be explicitly and proactively annunciated to warn the pilot when attitude information displayed by either PFD 102 sufficiently disagrees.

The first PFD 102(1), the second PFD 102(2), and/or the MFD 104 may receive additional data aggregated by the avionics unit 110 from one or more of a plurality of systems communicatively coupled with the avionics unit 110. For example, the avionics unit 110 may be communicatively coupled with and may aggregate data received from one or more of: an Automatic Dependent Surveillance-Broadcast (ADS-B) system 114, Traffic Collision Avoidance System (TCAS) 116, and a Traffic Information Services-Broadcast (TIS-B) system 118.

One or more of the displays PFD 102(1), PFD 102(2), MFD 104 of the avionics system 100 may be one of: an LCD (Liquid Crystal Diode) display, a TFT (Thin Film Transistor) LCD display, an LEP (Light Emitting Polymer or PLED (Polymer Light Emitting Diode) display, a cathode ray tube (CRT) display and so forth, capable of displaying text and graphical information. Further, one or more of the displays PFD 102(1), PFD 102(2), MFD 104 may be backlit via a backlight such that it may be viewed in the dark or other low-light environments.

The integrated avionics system 100 may include one or more controllers 120 which communicate with the avionics data bus 112. The controller 120 may provide a user interface (e.g., a touch interface) for the pilot for controlling the functions of one or more of the displays PFD 102(1), PFD 102(2), MFD 104 and for entering navigational data into the system 100. The avionics unit 110 may be configured for aggregating data and/or operating in an operating mode selected from a plurality of user-selectable operating modes based upon inputs provided via the controller 120.

In embodiments, the controller(s) 120 may be positioned within the instrument panel so that they may be readily viewed and/or accessed by the pilot flying the aircraft. The controller 120 furnishes a general purpose pilot interface to control the aircraft's avionics. For example, the controller 120 allows the pilot to control various systems of the aircraft, such as the autopilot system, navigation systems, communication systems, engines, and so forth, via the avionics data bus 112. In implementations, the controller(s) 120 may also be used for control of the integrated avionics system 100 including operation of the PFD 102 and MFD 104. In implementations, as shown in FIG. 3, the controller 120 includes a display unit 302. The display unit 302 of the controller 120 may be used for the display of information suitable for use by the pilot of the aircraft to control a variety of aircraft systems. The controller 120 will be discussed in further detail below. In various embodiments, the controller 120 is configured to function as a flight management system (FMS) that enables the creation and editing of flight plans in addition to other flight management functions. The avionics unit 110 may be configured to generate an air traffic display based upon the data that it receives and aggregates from the various systems, such as the ADS-B system 114 and the TCAS 116. For example, the avionics unit 110 is illustrated as including a traffic display module 214 which is storable in memory 212 and executable by the processor 210. The traffic display module 214 is representative of mode of operation selection and control functionality to access the received data (e.g., air traffic data) and generate an air traffic display based upon the received and aggregated data. The generated air traffic display may then be provided to and displayed by one or more of the display device(s) (e.g., PFD 102(1), PFD 102(2), or MFD 104).

FIG. 3 illustrates an example implementation showing the controller 120 in greater detail. The controller 120 is illustrated as including a processor 306, a memory 308, an avionics data bus interface 310, a keyboard 312, and the display unit 302. In some configurations, the various components of the controller 120 may be integrated or shared with the PFDs and MFDs. However, in other configurations, the components of the controller 120 may be separate and discrete from the components of the PFDs, MFDs, and other aircraft systems.

The processor 306 provides processing functionality for the controller 120 and may include any number of processors, micro-controllers, or other processing systems and resident or external memory for storing data and other information accessed or generated by the controller 120. The processor 306 may execute one or more software programs which implement techniques described herein. The processor 306 is not limited by the materials from which it is formed or the processing mechanisms employed therein, and as such, may be implemented via semiconductor(s) and/or transistors (e.g., electronic integrated circuits (ICs)), and so forth.

The memory 308 is an example of computer-readable media that provides storage functionality to store various data associated with the operation of the controller 120, such as the software programs and code segments mentioned above, or other data to instruct the processor 306 and other elements of the controller 120 to perform the functionality described herein. Although a single memory 308 is shown, a wide variety of types and combinations of memory may be employed. The memory 308 may be integral with the processor 306, stand-alone memory, or a combination of both. The memory 308 may include, for example, removable and non-removable memory elements such as RAM, ROM, Flash (e.g., SD Card, mini-SD card, micro-SD Card), magnetic, optical, USB memory devices, and so forth.

The avionics data bus interface 310 furnishes functionality to enable the controller 120 to communicate with one or more avionics data buses such as the avionics data bus 112. In various implementations, the avionics data bus interface 310 may include a variety of components, such as processors, memory, encoders, decoders, and so forth, and any associated software employed by these components (e.g., drivers, configuration software, etc.).

The display unit 302 displays information to the pilot of the aircraft. In implementations, the display unit 302 may comprise an LCD (Liquid Crystal Diode) display, a TFT (Thin Film Transistor) LCD display, an LEP (Light Emitting Polymer or PLED (Polymer Light Emitting Diode) display, a cathode ray tube (CRT) display, and so forth, capable of displaying text and graphical information. The display unit 302 may be backlit via a backlight such that it may be viewed in the dark or other low-light environments.

The display unit 302 may include a touch interface, such as a touch screen 304, that can detect a touch input within a specified area of the display unit 302 for entry of information and commands. In implementations, the touch screen 304 may employ one or more of a variety of technologies for detecting touch inputs. For example, the touch screen 304 may employ infrared optical imaging technologies, resistive technologies, capacitive technologies, surface acoustic wave technologies, and so forth. In implementations, the physical keyboard 312, which is electrically connected to the display unit 302, is used, in addition to the touch screen 304, for entry of data and commands. In further implementations, buttons, knobs and so forth, may be used, in addition to the touch screen 304 and keyboard 312, for entry of data and commands.

In the implementation illustrated in FIG. 4, a bezel 402 surrounds the display unit 302 and touch screen 304 to aesthetically integrate the display unit 302 and touch screen 304 with the instrument panel of the aircraft. One or more controls 404 may be provided in the bezel 402 adjacent to the display unit 302 and touch screen 304. In an implementation, the controls 404 may be control knobs, joysticks, buttons, indicia displayed within the display unit 302, combinations thereof, and so forth.

As shown in FIG. 4, the display unit 302 may be operable to display a graphical user interface (GUI) 406. In an implementation, the GUI 406 includes indicia 408 such as menus, icons, buttons (e.g., touch buttons), windows, text information, and/or other elements, which may be selected by the operator via the touch screen 304 to provide input to the controller 120 and/or control various functionalities associated with the integrated avionics system 100. Indicia 408 includes control indicia 408A that represents an interface to one or more applications of the integrated avionics system 100 that perform specific functions related to the control and operation of the aircraft. When the operator initiates an application (e.g., the operator touches the touch screen 304 corresponding to the graphical indicia 408A), the application causes specific functionality to occur, including but not limited to: selecting radio frequencies for communication with other entities such as air traffic control, other aircraft, and so forth; causing a graphical representation of flight path to be displayed at the MFD 104; causing air traffic information to be displayed at the MFD 104; causing weather forecasts and/or reports to be displayed at the MFD 104; causing a flight plan to be displayed at the MFD 104; causing waypoint information to be displayed at the MFD 104; causing aircraft system information to be displayed at the MFD 104; selection of entertainment media, and so forth. The above application functionality is described for example purposes only, and it is understood that the integrated avionics system 100 may incorporate additional applications configured to provide additional functionality depending upon the features of the integrated avionics system 100 and aircraft. The GUI 406 may also display text fields 410 (e.g., as part of indicia 408B) for providing a variety of data to the operator. For instance, the GUI 406 may include text fields 410 that provide setting information including, but not limited to: radio frequency settings, autopilot settings, navigational settings and so forth. In implementations, one or more of the settings may be adjusted by inputs from the operator via the touch screen 304, the keyboard 312, and/or the controls 404.

In the example implementation shown in FIG. 4, the keyboard 312 includes a plurality of alphanumeric keys 412, and function keys (e.g., quick access keys, shortcut keys) 414 for use in providing inputs to the controller 120. In embodiments, the function keys (e.g., shortcut keys) 414 allow a user to have full-time quick access to (e.g., to navigate directly to) one or more specific pages or data fields (e.g., text fields) displayable by the display unit 302 (e.g., for causing the one or more specific pages or data fields to be displayed by the display unit). In embodiments, the pages or data fields that are accessible via the function keys 414 of the keyboard 312 may also be accessible via inputs provided using the indicia 408 of the GUI 406. Thus, in some embodiments, as shown in FIG. 5, the keyboard 312 may not have the quick access keys. In the example implementation shown in FIG. 4, the keyboard 312 includes a scratchpad 416. In exemplary embodiments, the scratchpad 416 includes an input text display area and associated memory (e.g., memory 308) of the controller 120 and is configured for displaying and storing input text or input syntax associated with the alphanumeric keys 412 and/or function keys 414 of the keyboard 312 that have been activated (e.g., pressed) to provide inputs to the controller 120.

In the implementation of the controller 120 shown in FIG. 5, a visual scratchpad (e.g., the text display area of the scratchpad) 516 is provided in the touch screen 304, rather than on the keyboard 312. In some configurations, the scratchpad 516 is memory (e.g., a cache) for storing data input via the keyboard 312. In other configurations, the scratchpad 516 may include a display, presented on the keyboard 312, touch screen 302, and/or other portion of the avionics system, for visually indicating data input via the keyboard 312. The scratchpad 516 thus serves as a way to temporarily store and indicate information input via the keyboard 312.

The scratchpad 516 displays and/or stores input text or input syntax associated with the alphanumeric keys 412 and/or function keys 414 that have been activated (e.g., pressed) to provide inputs, via the keyboard 312, to the controller 120. Further, in the implementation shown in FIG. 5, rather than having function keys (e.g., quick access keys, shortcut keys) 414 on the keyboard 312, the function keys may be provided via indicia 408 displayed by the touch screen 304. In the implementations of the controller 120 shown in FIGS. 4 and 5, data entry may be provided to the controller 120 using standard flight management system (FMS) syntax (e.g., Latitude/Longitude (Lat/Lon), Waypoint/Bearing/Distance (WPT/BRG/DIS), Waypoint/Bearing/Waypoint/Bearing (WPT/BRG/WPT/BRG)).

In the implementation of the controller 120 shown in FIGS. 4 and 5, a user (e.g., pilot) may perform a keyboard-initiated input sequence in which he utilizes the keyboard (e.g., physical keyboard) 312 to provide an input (e.g., data) which is displayed as text (e.g., syntax) in the scratchpad (416, 516) (the scratchpad being on/in either the keyboard 312 or the GUI 406, depending on the controller implementation being used) and/or stored as data within the scratchpad (416, 516).

For example, if the user wants to enter a new speed target value for the aircraft, the user can initiate a keyboard input sequence for doing so by first providing an input via the keyboard 312, which then appears (e.g., as text, syntax, and/or data) in the scratchpad (of either the keyboard or the touch screen). The input provided via the keyboard 312 may include the new speed target value. The user can then provide an input via one of the indicia 408 (e.g., touch buttons) displayed by the GUI 406, the touch buttons corresponding to the input provided via the keyboard 312 and corresponding to the input text displayed in the scratchpad 416 of the keyboard 312. For example, the user may touch a touch button 408 labeled “speed target”. Providing the input via the touch button 408 rather than using a line select key (LSK), allows a user to bypass unnecessary/non-related pop-ups. Other example inputs include, but are not limited to, altitude, latitude/longitude, radial/distance, airways, procedures (arrivals, departures, approaches, and the like. The controller 120 then processes both the input provided via the keyboard 312 and the input provided via the touch button(s) 408 of the touch screen 304, including: checking the scratchpad (416, 516), determining that there is data (e.g., text) in the scratchpad, and parsing the text (e.g., data) displayed and/or stored in the scratchpad (416, 516) to determine if it can use the data (e.g., to determine if the data is valid for that touch button), and, when it determines that it can use the data (e.g., when it determines that the data corresponds to a proper input for changing the speed target value), changing (e.g., updating) the speed target value to the input value provided by the user (e.g., entering the data). The controller 120 parses scratchpad data in a similar manner as if the inputs were provided via LSKs.

Alternatively, if the user wants to enter a new speed target value for the aircraft, the user can perform a touch screen-initiated input sequence in which he initiates an input sequence for entering the new value by first providing an input via a touch button 408 displayed on the touch screen 304, the touch button 408 being associated with (e.g., labeled) speed target. The controller 120, processing the touch button-provided input, determines that there is no data in the scratchpad (416, 516), then causes the touch screen 304 to display a prompt, such as a context-specific data entry field or window, for allowing the user to enter the new speed target value. The user may then utilize the keyboard 312 for typing the new speed target value directly into the data entry field or the user may utilize a keyboard (input) window displayed on the touch screen 304. The controller 120 then processes the keyboard input, and changes (e.g., updates) the speed target value to the speed target value input by the user (e.g., the controller enters the data).

The above-referenced hybrid functionality provided by the herein described system allows users trained on different categories of currently-implemented controllers to efficiently use the herein described system to provide inputs. It achieves this by providing the speed advantages associated with physical keyboard entry, while also providing the intuitive touch screen interface. Of course, the speed target value example described above is for exemplary purposes and embodiments of the present invention may be utilized to input data and provide functionality associated with any features of the avionics system.

For instance, in the implementations of the controller 120 described herein, other navigational data, such as radio tuning data, may be provided (e.g., input) to the controller 120, as shown in FIGS. 6A and 6B. For example, the physical keyboard 312 may be utilized by a user for inputting a desired frequency into the scratchpad 616. In embodiments in which a sequence of inputs is initiated via the keyboard 312, once radio tuning data (e.g., a standby frequency, appearing as “228”) is entered into the scratchpad 616, a touch button 408, such as a standby or active frequency button (labeled “STBY” as shown in FIGS. 6A and 6B) may be touched by the user, thereby causing the radio tuning data (e.g., radio tuning value, standby frequency value) in the scratchpad to be processed and entered into the standby or active radio frequency button (where it appears as “122.80”, as shown in FIG. 6B) without any pop-up entry window appearing. Processing of the data occurs in a similar manner as described above in the speed target example in which the input sequence was initiated via the keyboard. In embodiments, the controller 120 allows for optional entry of a leading one and trailing zeroes when radio tuning data is input. Thus, a user wanting the standby frequency to be “122.80” as shown in FIG. 6B, can enter “228” in the scratchpad 616 (as shown in FIG. 6A), which is short-hand for a standby frequency of “122.80”.

In embodiments in which a sequence of inputs is initiated via the touch screen 304, such as the example of FIG. 11, the user touches a touch button 408 (e.g., a standby or active frequency button) displayed on the touch screen 304, a pop-up data entry field is displayed, and the user enters the radio tuning data directly into the pop-up data entry field. The radio tuning data is then processed and updated in a similar manner as described above in the speed target example in which the input sequence was initiated via the touch screen 304. In embodiments, the controller 120 allows for optional entry of VHF omnidirectional radio range identifiers (VOR Ident) for navigation (NAV) frequencies.

In embodiments, controls (e.g., dual concentric knobs) 404 of the controller 120 may be used to change the standby frequency of a COM that has knob focus. For example, the knobs 404 may be pressed and/or held by a user to change focus, flip-flop, or the like. In further embodiments, the controller 120 may be configured for displaying an audio/radios touch button 408 via the touch screen 304 which displays a list of radios, including Nays, High Frequencies (HFs), and/or the like. In embodiments, the audio/radios touch button may be controlled in a similar manner as the standby or active frequency button described above.

In the implementations of the controller 120 described herein, other navigational data, such as waypoint data, may be provided (e.g., input) to the controller 120, as shown in FIGS. 7A and 7B. In a keyboard-initiated (e.g., physical keyboard-initiated) input sequence, as shown in FIGS. 7A and 7B, a user can provide an input via the keyboard (e.g., physical keyboard) 312 to enter data into the scratchpad 716, the data including a new waypoint (e.g., “KSFO”) which the user would like added to the flight plan. The user can then provide a further input by touching a touch button 408 (“Add Waypoint” as shown in FIG. 7A) associated with the desired function on a flight plan page displayed by the touch screen 304. The inputs and data can then be processed in a manner similar to the other physical keyboard-initiated input sequence examples described above, thereby resulting in the new waypoint (e.g., “KSFO”) being added to the touch button, as shown in FIG. 7B. It is also contemplated that the new waypoint can be added via a touch screen-initiated input sequence (as described for other examples above).

In the implementations of the controller 120 described herein, other waypoint data, such as runway extension waypoints, may be provided (e.g., input) to the controller 120, as shown in FIGS. 8A and 8B. In a physical keyboard-initiated input sequence, as shown in FIGS. 8A and 8B, a user can provide an input via the physical keyboard 312 to enter data into the scratchpad 816, the data including a new runway extension waypoint (e.g., “KSFO.28R/280/10”) which the user would like added to the flight plan. The user can then provide a further input by touching a touch button 408 (“Add Waypoint” as shown in FIG. 8A) associated with the desired function on a flight plan page displayed by the touch screen 304. The inputs and data can then be processed in a manner similar to the other physical keyboard-initiated input sequence examples described above, thereby resulting in the new runway extension waypoint (e.g., “KSFO28”) being added to the touch button, as shown in FIG. 8B. It is also contemplated that the new runway extension waypoint can be added via a touch screen-initiated input sequence (as described for other examples above).

In the implementations of the controller 120 described herein, other waypoint data, such as along track offset waypoints, may be provided (e.g., input) to the controller 120, as shown in FIGS. 9A and 9B. In a physical keyboard-initiated input sequence, as shown in FIGS. 9A and 9B, a user can provide an input via the physical keyboard 312 to enter data into the scratchpad 916, the data including a new along track offset waypoint (e.g., “KLAX/20”) which the user would like added to the flight plan. The user can then provide a further input by touching a touch button 408 (“KLAX” as shown in FIG. 9A) associated with the desired function on a flight plan page displayed by the touch screen 304. The inputs and data can then be processed in a manner similar to the other physical keyboard-initiated input sequence examples described above, thereby resulting in the new along track offset waypoint (e.g., “KLAX −20NM”) being added to the touch button, as shown in FIG. 9B. It is also contemplated that the new along track offset waypoint can be added via a touch screen-initiated input sequence (as described for other examples above).

In embodiments, the controller 120 is configured for supporting various syntax formats for entry into the scratchpad 416. In embodiments, for runway extension waypoints, a user may enter “APT.RUNWY/BRG/DIST” (e.g., Airport.Runway/Bearing/Distance), and may select a runway endpoint in the flight plan. In embodiments, for Vertical Navigation (VNAV) constraints, a user may enter “A” or “B” following an altitude for an above or below constraint. Further, no suffix is required for an AT constraint. Still further, a user may select an altitude touch button next to a desired waypoint. In embodiments, for VNAV offset, a user may enter “WPT/BRG/DIS” (e.g., Waypoint/Bearing/Distance) or just “WPT//DIS” (if bearing is not known), and may select a waypoint in the flight plan to create an along track offset waypoint. In embodiments, for airways, a user may enter “AirwayName.ExitWPT” if the starting point (VOR, INT) is already in the flight plan, and may select the starting point of the airway in the flight plan to load the selected airway. Further, a user may enter “StartWPT.AirwayName.ExitWPT” if the starting point is not in the flight plan, and may select an add waypoint button to add at the end or the waypoint to insert it in front of.

Generally, any of the functions described herein can be implemented using software, firmware, hardware (e.g., fixed logic circuitry), manual processing, or a combination of these implementations. The terms “module” and “functionality” as used herein generally represent software, firmware, hardware, or a combination thereof. The communication between modules in the integrated avionics system 100 of FIG. 1, the avionics unit 110 of FIG. 2, and/or the controller 120 can be wired, wireless, or some combination thereof. In the case of a software implementation, for instance, the module represents executable instructions that perform specified tasks when executed on a processor, such as the processor 210 of the avionics unit 110, or the processor 306 of the controller 120. The program code can be stored in one or more storage media, an example of which is the memory 212 associated with the avionics unit 110 or the memory 308 associated with the controller 120. While an integrated avionics system 100 is described herein, by way of example, it is contemplated that, the functions described herein can also be implemented in one or more independent (stand-alone) avionics units or systems implemented within an aircraft, such as an aircraft that does not include an integrated avionics system.

Example Procedures

The following discussion describes procedures for data handling via the implementations of the controller 120 described herein. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the integrated avionics system 100 of FIG. 1, the avionics unit 110 of FIG. 2, and the implementations of the controller 120 shown in FIGS. 3, 4, and 5.

FIG. 10 illustrates a procedure (e.g., method) 1000, in an example implementation, in which a controller 120 of an integrated avionics system 100 implemented on-board an aircraft may provide hybrid functionality for handling input user data provided via either a physical keyboard-initiated input sequence or via a touch screen-initiated input sequence. In embodiments, the procedure 1000 includes a step of receiving a first input, the first input received via a physical (e.g., tangible) keyboard of the controller (Block 1002). For example, the first input may be or may include data, text and/or syntax for providing navigational data to the controller 120, such as a new speed target, frequency data, waypoint data, or the like, which was entered by the user by pressing keys of the physical keyboard.

In embodiments, the procedure 1000 further includes a step of storing the first input (Block 1004). For example, the first input can be stored in a portion of memory 308 of the controller 120 associated with a scratchpad 416 of the controller 120 and displayed via a text display area associated with the scratchpad 416. The text display area associated with the scratchpad (416 or 516) can be located on the physical keyboard 312 (as shown in FIG. 4) or on the touch screen 304 of the controller 120 (as shown in FIG. 5).

In embodiments, the procedure 1000 further includes a step of receiving a second input, the second input received via a touch button displayed by a touch screen of the controller (Block 1006). For example, the second input may be provided by touching a touch button 408 displayed by the touch screen 304. Further, the touch button 408 corresponds to the first input.

In embodiments, the procedure 1000 further includes a step of processing the received first input and the received second input (Block 1008). In embodiments, processing of the received first and second inputs by the controller 120 includes: parsing the stored first input to determine if the first input is compatible with the second input (Block 1010). For example, the controller 120 determines that text (e.g., the first input) is displayed in the scratchpad (416, 516), and it determines if the text (e.g., first input) displayed in the scratchpad (416, 516) is valid for the touch button 408 used to provide the second input (e.g., determines if the first input is compatible with the second input).

In embodiments, the procedure 1000 further includes a step of, when the first input is determined as being compatible with the second input, causing data associated with the first input to be displayed via the touch button (Block 1012). For example, when the controller 120 determines that the first input (e.g., displayed via the scratchpad (416, 516)) is valid for the touch button 408 used to provide the second input, the data (e.g., new value) associated with first input is entered and displayed in the touch button 408.

In embodiments, the procedure 1000 further includes a step of receiving a third input, the third input received via the touch button displayed by the touch screen of the controller (Block 1014).

In embodiments, the procedure 1000 further includes a step of processing the third input and, based upon the processing of the third input, causing a data entry area to be entered and displayed via the touch screen. (Block 1016). For example, during processing of the third input, the controller 120 determines that no data is in the scratchpad (416, 516) and causes a data entry area (e.g., pop-up screen, data entry field, a context-specific data entry window) associated with the third input to be displayed. In embodiments, the data entry area corresponds with (e.g., is included in) the touch button via which the third input was received.

In embodiments, the procedure 1000 further includes a step of receiving a fourth input, the fourth input being received via the physical (e.g., tangible) keyboard of the controller (Block 1018) or the touch screen. For example, after the data entry area (e.g., context-specific data window) associated with the third input is displayed, the fourth input (e.g., data, a new value) is provided via the physical keyboard 312 for entering data (e.g., text) into the data entry area of the touch button 408.

In embodiments, the procedure 1000 further includes a step of processing the fourth input and based upon said processing of the fourth input, causing data associated with the fourth input to be displayed via the touch button (Block 1020). For example, the data associated with the fourth input is displayed in the data entry area of the touch button.

### CONCLUSION

Although the integrated avionics system 100 has been described with reference to example implementations illustrated in the attached drawing figures, it is noted that equivalents may be employed and substitutions made herein without departing from the scope of the invention as recited in the claims. Further, the integrated avionics system 100 and its components as illustrated and described herein are merely examples of a system and components that may be used to implement the present invention and may be replaced with other devices and components without departing from the scope of the present invention.

What is claimed is:

1. A controller for implementation on-board an aircraft, the controller comprising:
a physical keyboard;
a memory, the memory being communicatively coupled with the keyboard;
a processor, the processor being communicatively coupled with the memory; and
a touch screen, the touch screen being communicatively coupled with the processor,
wherein the processor is operable to enable a keyboard-initiated input sequence and a touch screen-initiated input sequence, the processor being configured for:
receiving a keyboard input via the keyboard,
receiving a touch input via the touch screen,
processing the keyboard input and the touch input to determine if the keyboard input is compatible with the touch input, and
when the keyboard input is determined as being compatible with the touch input, causing data associated with the keyboard input to be entered and displayed via the touch screen.

2. The controller as claimed in claim 1, wherein the processor is further configured for:
receiving a third input, the third input being received via a touch button associated with the touch screen;
when the keyboard input is not compatible with the third input, causing a data entry area to be displayed via the touch screen,
receiving a fourth input, the fourth input being received via the data entry area displayed via the touch screen, and
causing data associated with the fourth input to be displayed via the touch screen in proximity to the touch button.

3. The controller as claimed in claim 1, wherein the keyboard input is compatible with the touch input when the keyboard input is valid for a touch button associated with the touch input.

4. The controller as claimed in claim 1, wherein the memory is associated with a scratchpad of the controller.

5. The controller as claimed in claim 1, wherein the touch input is associated with a touch button.

6. The controller as claimed in claim 1, wherein the touch input is associated with a communication frequency button and the keyboard input is compatible with the touch input if the keyboard input corresponds to a communication frequency.

7. The controller as claimed in claim 1, wherein the touch input is associated with a navigation frequency button and the keyboard input is compatible with the touch input if the keyboard input corresponds to a navigation frequency.

8. The controller as claimed in claim 1, wherein the touch input is associated with a waypoint button and the keyboard input is compatible with the touch input if the keyboard input corresponds to a waypoint.

9. The controller as claimed in claim 1, wherein the touch input is associated with a speed target button and the keyboard input is compatible with the touch input if the keyboard input corresponds to a speed target value.

10. A controller for implementation on-board an aircraft, the controller comprising:
a physical keyboard;
a memory communicatively coupled with the keyboard;
a processor communicatively coupled with the memory; and
a touch screen communicatively coupled with the processor,
wherein the processor is operable to enable a keyboard-initiated input sequence and a touch screen-initiated input sequence, the processor configured for:
receiving a keyboard input via the keyboard,
receiving a touch input via the touch screen,
processing the keyboard input and the touch input to determine if the keyboard input is compatible with the touch input;
when the keyboard input is determined as being compatible with the touch input, causing data associated with the keyboard input to be entered and displayed via the touch screen.
receiving a third input, the third input being received via a touch button associated with the touch screen;
when the keyboard input is not compatible with the third input, causing a data entry area to be displayed via the touch screen,
receiving a fourth input, the fourth input being received via the data entry area displayed via the touch screen, and
causing data associated with the fourth input to be displayed via the touch screen in proximity to the touch button.

11. The controller as claimed in claim 10, wherein the keyboard input is compatible with the touch input when the keyboard input is valid for a touch button associated with the touch input.

12. The controller as claimed in claim 10, wherein the memory is associated with a scratchpad of the controller.

13. The controller as claimed in claim 10, wherein the touch input is associated with a touch button.

14. The controller as claimed in claim 10, wherein the touch input is associated with a communication frequency button and the keyboard input is compatible with the touch input if the keyboard input corresponds to a communication frequency.

15. The controller as claimed in claim 10, wherein the touch input is associated with a navigation frequency button and the keyboard input is compatible with the touch input if the keyboard input corresponds to a navigation frequency.

16. The controller as claimed in claim 10, wherein the touch input is associated with a waypoint button and the keyboard input is compatible with the touch input if the keyboard input corresponds to a waypoint.

17. The controller as claimed in claim 10, wherein the touch input is associated with a speed target button and the keyboard input is compatible with the touch input if the keyboard input corresponds to a speed target value.

18. A method of hybrid operation of an avionics system providing both a keyboard-initiated input sequence and a touch screen-initiated input sequence, the method comprising:
receiving a keyboard input received via a physical keyboard of the avionics system;
storing the keyboard input;
receiving a touch input received via a touch screen of the avionics system;
parsing the keyboard input to determine if the keyboard input is compatible with the touch input;
when the keyboard input is determined as being compatible with the touch input, causing data associated with the keyboard input to be entered and displayed via the touch screen;
receiving a third input, the third input received via the touch button displayed by the touch screen of the controller; and
processing the third input and, based upon the processing of the third input, causing a data entry area to be entered and displayed via the touch screen, the data entry area being located in the touch button.

19. The method as claimed in claim 18, wherein the keyboard input is compatible with the touch input when the keyboard input is valid for a touch button associated with the touch input.

20. The method as claimed in claim 19, wherein the touch input is associated with a communication frequency button and the keyboard input is compatible with the touch input if the keyboard input corresponds to a communication frequency.
